(19) United States
(12) Patent Application Publication
(10) Pub. No.: US 2005/0035041 A1
(43) Pub. Date: Feb. 17, 2005

(54) Hollow fiber membrane filters in various containers

(76) Inventors: John E. Nohren JR., St. Petersburg, FL (US); Bradley D. Mierau, Tampa, FL (US); John T. Smith, Dunedin, FL (US)

Correspondence Address: NIXON & VANDERHYE, PC, 1100 N GLEBE ROAD, 8TH FLOOR, ARLINGTON, VA, 22201-4714, US

(21) Appl. No.: 10/486,346

(22) PCT Filed: Aug. 12, 2002
(86) PCT No.: PCT/US02/25188

(30) Foreign Application Priority Data
Aug. 10, 2001 (US) 60311098

(51) Int. Cl. C02F 1/44

(52) U.S. Cl. 210/209; 210/266; 210/321.89

(57) ABSTRACT

A water filter cooperable with a water container includes both a carbon composite filter (30) and a bundle of micro porous hollow fiber membranes (5) in fluid communication with the carbon composite filter (30). An influent side of the hollow fiber membrane (5) is continuously immersed in water whereby air is prevented from being reintroduced to the hollow fiber membrane (5).

### BACKGROUND OF THE INVENTION

The need to treat water in an economical and convenient manner for biological contamination by people away from home, and as they travel, or simply conducting their daily activities has become more evident. While technology allowing filtration of microorganisms from drinking water in a squeezable “sports” bottle is available, a number of serious inadequacies limit the application of microbial filters in these bottles. For the removal of protozoan cysts from water, an effective pore size between 1 and 3 microns in the filtration medium is recommended, while for retention of bacteria particles an order of magnitude smaller must be excluded. Filtration media possessing the capability to exclude particles in this size range is relatively dense, inhibiting the flow of water through the media as well as the material to be filtered out. The apparent dilemma in designing small filters that are effective at removing bacteria in particular, and cysts is that the pressure drop per unit surface area is large while the available surface area is small.

One approach to alleviating this restriction is to loosen the pore sizes of the filter to allow particles to be deposited throughout the depth of a bed of media. As the flow path of the water is designed to be torturous, the hope is that weak surface interactions such as van der Waals forces will trap the particles somewhere along the surfaces of the flow paths before they are flushed from the bed. This technology is less desirable from a reliability standpoint than techniques that mechanically screen the particles from the water. Monolithic filters, such as carbon blocks, employ the depth and tortuous path filtration mechanism for particles. They must use this method because filtering out material onto the surface of such structures would result in low capacities due to the pressure required and the small amount of surface area available. Reducing the pore size in these blocks would grossly enhance fouling, and substantially increase the pressure required to achieve a particular flow rate.

Another approach to providing for more surface area within a small volume is to employ hollow fiber membranes as the filtration media for size exclusion. The large surface to volume ratio of the hollow fibers greatly increases the area available for contact with the bulk fluid phase. But even with the application of hollow fiber membrane bundles, the pressure drop across a filter capable of being deployed as a portable bottle filter is substantial. For hollow fiber bundles of the approximate dimensions 7.3 Cm in length and 3 Cm in diameter, such as that produced by Spectrum Laboratories, the flow rate through the bundle under pressures capable of being effectively supplied by hand squeezing is fairly low. At an applied pressure of 10 psig, the initial flow rate through such a bundle is around 12 to 35 ml per second. Any blockage or other restriction to the flow of water through the membrane bundles results in even slower flow rates; possibly low enough to no longer be acceptable in actual usage.

An unfortunate problem in the use of hollow fiber membrane bundles in sport bottle applications is that if air accumulates inside the bundle housing between uses, a large percentage of the bottle squeeze must be used to expel air from the filter. Because the air vents by flowing through some of the fiber bundles, while the air is venting the flow of water exiting the filter is lessened. Testing has shown that it may take several minutes of continuous flow to fully purge the filter of air. As the acceptability of the liquid flow rate is already marginal under normal use conditions, any reduction in flow results in a significant decrease in performance. Another problem that may be encountered if air is allowed back into the membrane is with entrapped air causing actual membrane blockage. The hollow fiber bundle referenced by Shimizu in U.S. Pat. No. 5,681,463 suffers from both problems as water will drain from the fiber bundle housing as the bottle is returned to an upright position.

### BRIEF SUMMARY OF THE INVENTION

The present invention eliminates the problem of reintroduction of air into the bundle housing between uses preferably by enclosing the axially joined filter elements (the hollow fiber bundle and carbon elements) within an impervious shroud that maintains the water level in contact with the hollow fibers. Thus, between uses, the water within the hollow fiber housing is not allowed to drain, preventing the accumulation of additional air that must be voided for full efficiency. This same approach has been employed in other designs disclosed in this application to preclude the water from draining from the hollow fiber membrane filter. A second method that may be used when the water intake is at the base of the housing and the filter is positioned at the base of a water bottle or canteen is to employ a one-way valve which will not permit the water to drain back into the bottle or container.

In an exemplary embodiment of the invention, a water filter is cooperable with a water container. The water filter includes a carbon composite filter and a bundle of sub-micro porous hollow fiber membranes in fluid communication with the carbon composite filter. The carbon composite filter and the hollow fiber bundle are arranged in the water container such that untreated water is first treated with the carbon composite filter and then directed to the hollow fiber bundle. An influent side of the hollow fiber bundle is continuously immersed in water, whereby air is prevented from being re-introduced to the hollow fiber bundle from outside the water filter between inversions of the water container or when the water container is upright.

In another exemplary embodiment of the invention, a filtration system for filtering water includes a water container and the water filter according to the present invention.

In still another exemplary embodiment of the invention, a dual component water filter includes a hollow fiber membrane bundle and a screen pre-filter. The hollow fiber membrane bundle and the screen pre-filter are contained within a single housing, wherein the housing retains water within the hollow fiber membrane bundle and the screen pre-filter.

### BRIEF DESCRIPTION OF THE DRAWINGS

FIG. 1 shows a sport type bottle top mounting the filter of the present invention in a nested arrangement;

FIG. 2 illustrates the filter of the present invention in a tandem end-to-end configuration;

FIG. 3 shows the filter assembly of FIG. 2 incorporating a viricidal disinfecting injection unit;

FIG. 4 shows a free-standing filter assembly adapted to straw use;

FIG. 5 illustrates the dual element filter of the present invention designed to mount to a specially designed cap for use in conjunction with a container such as a bladder or hydration pack that collapses as the water is removed;

FIG. 6 shows the filter of the present invention adaptable to either soft or vented containers and fastened to the base or bottom of the container;

FIG. 7 illustrates a filter design according to the present invention positioned within a military canteen;

FIG. 8 shows the filter of the present invention adapted for use in standard 28 mm neck PET bottles;

FIG. 9 illustrates a filter of the present invention that may be used to drink through from a glass or cup or a bottle through a straw;

FIG. 10 illustrates the filter of the present invention adapted for use in a relatively narrow neck bottle similar to the international standard 28 mm; and

FIG. 11 shows the filter assembly of the present invention with a minimized length.

### DETAILED DESCRIPTION OF PREFERRED EMBODIMENTS

In the selection of hollow fiber membrane bundle technology over monolithic block approaches, a major concern is the potential for microbial break-through or grow-through occurring as increasing volumes of fluid are passed through the monolithic filter. Because of the surface loading and pressure drop restrictions mentioned above, these monoliths must employ larger effective pore sizes than high surface to volume ratio materials such as the hollow fiber membranes. The potential for failure is clearly higher in the carbon block monolithic filters purported to be designed for microbe removal. Filters of this nature have mean pore sizes in the neighborhood of 10 microns. The monoliths are often reported to have a capacity of as much as 100 gallons, further raising concerns about bacteria and protozoa being washed through the device. In contrast, the hollow membrane fibers for bacteria removal typically have a mean pore size approximating 0.15 microns with a range between 0.02 and 0.4, with actual capacities of 75 or more gallons, depending upon pretreatment and the turbidity of the water.

It is of course important to remove bacteria as well as protozoa. Many water born diseases, including some of the most serious, are caused by bacteria in the water. Viral diseases are not easily amenable to removal via filtration, and are normally controlled through the use of chemical disinfectants. In employing media with effective pore sizes appropriate for protozoa and bacteria removal in portable products which do not employ mechanical pumps, the pressure drop from the container through the filter and out to the user will be from 2 psig when first used and approaches 10 psig, deemed a practical limit of usability for the average person after extended use. Antimicrobial filters for use in sport bottles typically also incorporate activated carbon for the removal of specified chemical species from the water. If organized as separate structures, the tendency of these carbon elements to become fouled with particulates need not be as great as the element used for microbial removal even though they act as a pre-filter. To maintain the lowest pressure drop, independent filters should be used that are separately installed and complement one another. The principal advantage to maintaining separate filter elements with differing useful lives is that each can be replaced independently, depending upon need. This also permits the user to revert to a single filter if the need for dual treatment is not required. Thus, both convenience and economy are gained.

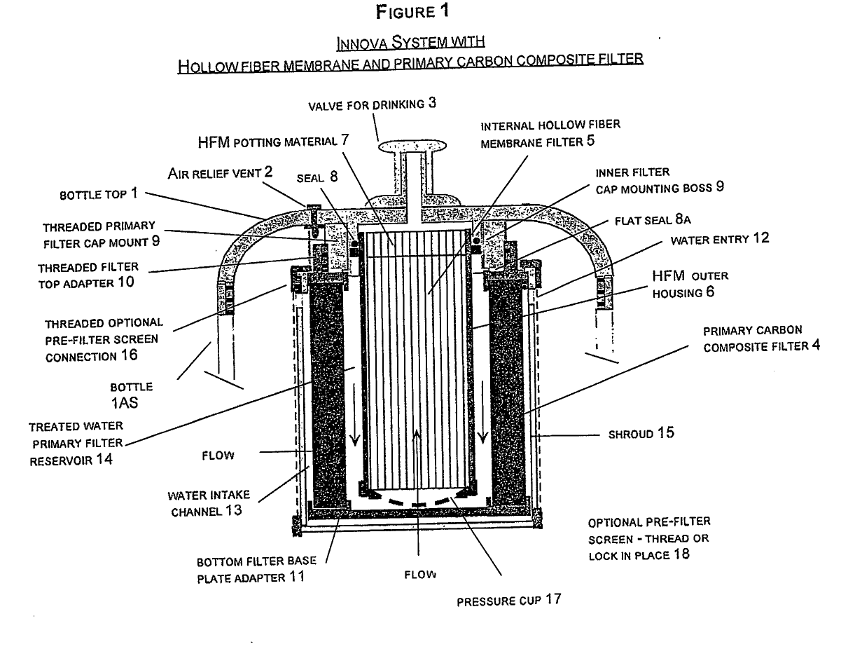

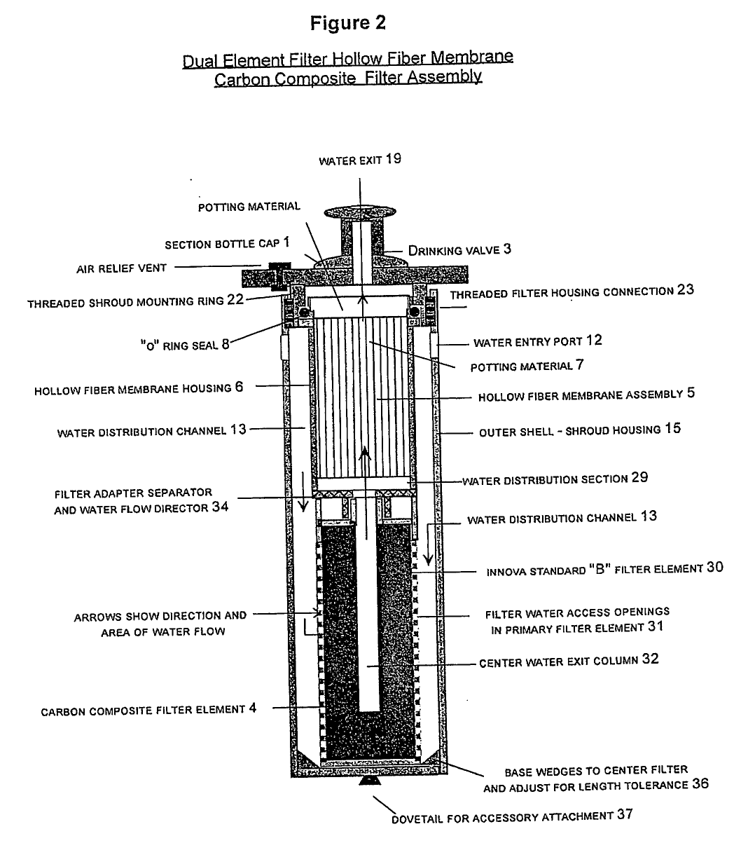

A superior approach permitting the very effective removal of bacteria, as well as protozoa, while retaining the ability to independently integrate a carbon composite, or other filter, and without the reduction in flow rate resulting from air blocking the passage of water, has been developed according to the present invention. The present invention as shown in FIGS. 1-11 extends the life and use of the biological filter element relative to that of the noted Shimizu patent, by utilizing a larger bundled Hollow Fiber Membrane (HFM)—monolithic carbon element which extends below the neck of the bottle. While the membrane bundle may only be two-three inches in length and one inch in diameter, as much as one and one-half square foot of membrane area exists. Thus, while the effective pore size is between 0.02-0.4 micron, with 0.05-0.2 preferred, pressure drop remains around 10 psig, or less. The filter assembly includes a complementing high performance carbon composite element with an average pore size between 10-50 microns, with a preferred porosity of 20 microns capable of removing greater than 80% of the chlorine and greater than 90% of lead at a flow rate of 10 ml/sec. Thus, by combining the HFM with the carbon composite filter, protozoa, bacteria, lead, chlorine, taste and odor are removed. Other selected metals and chemical contaminants are likewise reduced. The pre-filtration of fine particulate matter can be enhanced by increasing the wall thickness of the carbon composite pre-filter. Under turbid conditions it is also desirable to add a third element, a screen pre-filter or other type of particulate filter which can be one of several different designs including a thin wall ceramic or fiber depth filter. The screen, possessing openings of approximately 10 microns, has been found to be satisfactory as it is cleanable, yet very light weight, and occupies the least amount of space, which in a portable product is at a premium. Another example to basically provide the same general performance is shown in FIG. 2. The component filters are shown stacked, or in tandem, as frequently referred to. The filters in FIG. 1 are nested, making interchange somewhat easier while providing minimum pressure while allowing larger and higher capacity carbon composite filters to be integrated. The advantage of the tandem design is the smaller total diameter and thus the ability to fit into a substantially smaller neck bottle. Both designs may include a third pre-filter screening element.

Neither filter design is self-venting, thus it is necessary to incorporate a vent with a one-way valve to permit the bottle to re-inflate after taking filtered water from the bottle. Drinking is typically accomplished by opening the valve at the top of the bottle, placing the push-pull mouth piece into ones mouth and squeezing the bottle. The squeezing force may be enhanced by sucking on the mouthpiece or “straw” at the same time. By integrating the air relief valve into the bottle rather than the filter venting, it is not necessary for the HFM to evacuate the water held within the membrane, thus materially enhancing ease of use and eliminating the potential for an air blockage. There is also an advantage to not incorporating the relief valve within the filter, as it would be a potential point of leakage and contamination. A Silicon umbrella relief valve, with a cracking pressure between 0.5-3 psig, is mounted within a recess formed into the bottle, protecting the valve from external contact. This is a unique approach to maintaining the rapid flow of water without the back flushing of either filter occurring. Optionally, the air relief valve may also be installed within the bottle top itself which supports the filter in most instances. It is further recognized that there are three distinct classes of biological contamination: protozoa cysts, bacteria, and virus. Protozoa are typically larger than 3 microns; bacteria are, for the most part, larger than 0.3 microns, both of which may be filtered out. The third form of biological contamination found in nature consists of virus, which must be chemically devitalized, as they are too small to be filtered out by mechanical means that would be usable in a portable filter bottle product. In the instances of natural disaster, as well as in the developing world, viral pestilence in the only available water can represent life threatening problems. Thus, it is desirable for a product to be able to be adapted to all biological problems and situations and to the degree possible provide a means of viral devitalization when necessary. With the proposed products the treatment for virus would be done by chemical means through the addition of chlorine or other water disinfectant.

To this end, a third and optional component injects a disinfecting chemical such as a modified chlorine dioxide solution, or other available disinfectant. In operation, the chemical injecting element is affixed to the base of the housing containing the carbon composite filter and the 0.2-micron hollow fiber membrane element. Functionally, each time the filter assembly is removed from the bottle the chemical injection mechanism charges. After the bottle is filled with water, the filter assembly is reinserted. As the filter assembly is threaded onto the bottle, a precise quantity of the chosen disinfectant is metered into the water. The disinfection chemical devitalizes the viral contaminants in a specified time period, during which the user must wait prior to drawing water from the purifying unit. Alternatively, the user may make use of an effective chlorine based tablet or other such disinfecting product and administer the same to the water manually, placing the chemical element into the bottle following the manufacturer's directions.

The Hollow Fiber Membrane for removal of Protozoa Cyst and Bacteria from water combined with a pre-filter also has wide application for use with canteens as well as collapsing bag type containers. Applications of this nature extend to gravity feed water bags. In the area that would normally sustain the pull push segment of the valve, the pull push portion is adaptable to fasten to a tube or hose which in turn can be used to fill a second container. The bag with the raw water containing the filter is typically hung upside down allowing the water to drain through the filter into the second container. Applications of this nature rely primarily upon gravity, or a combination of gravity and siphon action, to draw the water through the filtration elements. Typically, the container of water is not squeezed or otherwise pressurized to effect water transfer. This is similar to the filter arrangement used in conjunction with a 2 to 5 gal. cooler or crock type bottle. The filter once again is used in the inverted mode with flow controlled by means of the water level rising within the receiving container (crock) until the air supply leading back into the container by means of a vent tube is closed off.

For the various applications, typically the secondary filter is a housed HFM bundle to which a carbon composite primary filter is attached. A carbon composite block type filter functions as the primary filter providing selected chemical and heavy metal removal while at the same time performing a pre-filtration function removing all but the fine sediment particles. Alternately to the carbon block, a non-woven carbon cloth depth filter or fine mesh screen of approximately 10-micron may be used for turbidity reduction. By so doing the size and weight is reduced, but at a loss of performance, compared with the monolithic carbon block composite filter. Regardless of the primary filter element used, all elements are independently replaceable. The design can be suitable for neck diameters above 35 mm.

The monolithic carbon composite filter is typically of a radial flow nature and nominally of 20-micron pore size. Preferably, the composite material consists of activated carbon, binder and may contain zeolyte, ion exchange materials and polymer extractive material as well. The carbon composite filter will remove greater than 90% of lead and mercury that may be present, as well as 80% or greater of chlorine to a minimum of 70%, taste and odor toward the end of the useful life of the filter at 20 gal with a flow rate of 10 ml per second. The chlorine capacity of the primary filter is advantageous when chlorine is used to treat for virus. The hollow fiber filter may be as small as 0.1˜0.3 micron and reject particles from 0.05˜0.07 micron as a result of the wall thickness of the membrane. A minimum three-log reduction of Protozoa and 6-log reduction of bacteria is achieved over the life of the filter. The so-constructed filter removes protozoa and bacteria to levels as required by Government standards for a treatment device of this nature, 99.9999% for bacteria and 99.9% for protozoa The filter is capable of treating from 20 to 100 gallons of water with a pressure drop across the treatment system of not more than 10 psi with an average turbidity factor of less than 1 NTU (nephelometric turbidity units). Filter Life is determined when water can no longer be passed through the filter. This preferred combination of the primary carbon composite filter and hollow fiber membrane secondary filter has met the testing requirements of the EPA protocol.

Is important to recognize that the functions provided by the subject invention serve the same useful purposes in various size bottles or containers. Typically, the neck size of the bottle would range from 28 mm through 63 mm in nominal diameters. This provides a significant challenge as the larger the components the more adaptable they become and easier to meet the performance requirements while retaining a high degree of utility for the product. The larger 63 mm neck offers the opportunity to nest the filter components; the hollow fiber membrane within a larger diameter carbon composite filter. The 53 mm diameter neck size bottle is better served by placing the individual filter components in tandem whereas bottles with a neck diameter of from 35 mm to 28 mm are easier to produce using an axial flow carbon element feeding into the H F M housing with radial flow into the actual membrane structures. The carbon element used in the smaller neck size may be the carbon composite molded filter element or a filter constructed from carbonized nonwoven materials.

Due to the variation in container neck size and the mode (attitude) the bottle is in when used, a variety of designs have been created to evacuate most all the water from the container, as used. Typically when applied to a sport type bottle, the bottle is elevated or tipped up to drink causing the water to accumulate at the top rather than the bottom of the bottle. In order to be able to remove, by drinking, most of the water in the bottle through the filter, an annulus reservoir is used which takes the water from the bottle cap or top of the bottle and distribute the water to the filtration elements. The filter annulus reservoir also maintains the level water in contact with the hollow fiber membrane element to preclude the draining of the element when not in use. An annulus system of this nature is used with sufficiently wide bottlenecks to permit its adaptation, typically 53 to 63 mm neck bottles although it may be used with smaller neck bottles into the range of 38 mm diameter neck diameters. The annulus reservoir is a separate closed-end plastic tube which threads onto the cap with water entry ports just below the threaded section. The annulus formed between the filter elements and the annulus reservoir housing is relatively small, approximately 0.020-0.100 of an inch.

When dealing with smaller bottle openings which require smaller filter elements, it has been found desirable to use a single housing to encapsulate both the hollow fiber membrane as well as the carbon filtration element, should a carbon filtration element be desired. Rather than to provide a separate filter annulus reservoir, it has been found desirable to simply mold or cut longitudinal grooves from the base of the single filter housing to within approximately three-quarters of an inch from the top of the housing. The top of the housing is the section within which the hollow fiber membranes are bonded and to which the fitting to the bottle top is incorporated. Access holes at the base of the longitudinal grooves permit the water to flow into the inner filtration area of the housing. From the base of the housing to within approximately 1/8 of an inch from the top end of the longitudinal grooves, a plastic sleeve is used to seal the grooves turning them into water feed channel. Thus, the same features are achieved with a much smaller neck size as found in the larger diameter filter assembles using separate annulus reservoir housings.

There are also bottles, or containers, whose preferred drinking orientation is in the vertical upright plane. To accommodate this position for the larger diameter bottles, the use of the annulus reservoir is reversed for water pick-up which in turn feeds a secondary upright annulus maintaining the water level to the filter elements precluding the draining of the hollow fiber membrane and the intrusion of air into this filter element.

When it is desirable to drink from the container in the vertical upright plane, yet mount the filter to either the top of the container directly or position the filtration unit through the use of a flange resting upon the top surface of the neck of the bottle which becomes operatively connected to the bottle top, a water intake tube is used to feed water into the filtration elements. The intake tube maybe used to either feed the water into a reservoir annulus for feeding into a radial flow carbon composite filter, or directly into an axial flow carbon filtration element. In either case it is necessary to employ a valve to retain all water within the filtration elements to preclude draining of water from the filtration elements back into the bottle. Several types of valves may be used for this purpose but a simple duckbill valve is both simple and reliable.

The present-day military canteen offers a significant challenge. A military canteen is best served by a filtration assembly that can remove bacteria, protozoa, and chlorine, as a minimum. The purpose of the chlorine is to devitalize virus that may be present. And effective carbon composite filter will remove the taste and the odor of the chlorine rendering the water palatable to the user. It is highly desirable to be able to remove a host of other chemical contaminants, as well. While potentially possible, it is problematic due to the size constraints imposed by the canteen and the neck size of the canteen. As the canteen must be available for hydration regardless of whether the user is wearing a gas mask, or the access to the canteen is restricted and thus a drinking tube is used, or for unrestricted use water may be drawn from the canteen by means of a straw. Thus, both a drinking straw as well as the fitting for a drinking tube are desirable. A dual-purpose top has been developed that integrates the multipurpose filtration unit that may be easily used in either mode. When not used the two available drinking outlets are independently sealed for cleanliness. The top also contains a reservoir for filtered water that may feed either of the two drinking outlets as well as an air relief valve, and an orientation notch to radially position the filtration unit. The filtration unit housing contains a longitudinal disposed air relief tube extending from the air relief valve chamber to the base of the filtration unit. However, the relief tube may terminate at any point along the housing suitable for releasing the air back into the canteen. The housing also contains the hollow fiber membrane biological filter, a filter separator, and the carbon composite filter made up of either carbonized nonwoven cloth, or a monolithic carbon block element.

The carbon filter choice in a unit of this type is challenging, both to remove the potential chlorine loading the filter may be subject to, as well as to provide a relatively low pressure drop across the filter to provide at the optimum, a flow of 10 ml/sec with a force of 2 psig. This force can be extended upward to approximately 10 psig. Due to the diameter constraints the simplest design uses the carbon filter elements in an axial flow configuration.

One alternative to enhance the carbon element is to use an external carbon wrap over the housing operating in a radial flow mode. The water would feed from the external surface of the carbon element through louver openings in the HFM housing and hence feed by means of a tube to the distribution chamber within the cap. This design can be particularly attractive for military use where the maximum practical size carbon element may be desirous to employ.

FIG. 1 shows a sport type bottle top 1 with valve 3, which mounts two independent filters 4 and 5. As shown in FIG. 1, an inner hollow fiber membrane (HFM) filter 5 is attached to the bottle top 1 by means of a friction or threaded fit to the inner upper diameter of the filter mounting ring 9, which is a component of and extends down from the top. The placement of the HFM filter 5 into the mounting ring 9 compresses the “0” ring seal. In a similar manner the primary filter 4, consisting of a monolithic carbon composite mixture, is affixed by means of a threaded top adapter 10 to the threaded cap mount 9. The composite filter 4 is cylindrical in shape and is mounted to the top threaded adapter 10 and the bottom base 11 by means of a simple adhesive yet water tight bond. The HEM housing 6 is retained in position relative to mounting boss 9 with the axial loading exerted by the porous spring pressure cup 17. A shroud housing 15 is used to allow evacuation of most of the water within the bottle. The water entry port 12 is indicated from which water flows into the distributing channel 13 prior to passing sequentially through the filter elements 4 and into the secondary treated water reservoir 14 prior to entering at the base of the membrane filters 5, hence to exit fully treated through the valve 3. A one-way valve to permit the bottle to re-inflate after water has been removed is shown at 2. Seals to prevent leakage are represented by 8 and 8A. The hollow fiber membrane bundle housing 6 is retained within the housing by the potting compound 7. The optional pre-filter screen 18 of approximately 10-micron pore size is used to remove excess turbidity or particulate matter. The screen may be easily removed and cleaned by brushing. A pressure cap 17 fits to the base of the hollow fiber membrane housing 6 and retains the hollow fiber membrane filter 5 in its position with the sealing surfaces 8 and 8A in conjunction with the bottle top 1.

FIG. 2 shows essentially the same components arranged in tandem rather than in a nested orientation. This configuration is useful when the container or bottle neck diameter is limited. A section of a typical sport bottle cap is shown 1, containing a valve 3, and an integral filter mounting ring boss 22. While there are many ways that the filter assembly contained within the outer shell 15 can be affixed, for the purpose of illustration, a threaded connection 23 is shown. The primary carbon composite filter 30 is centered by the centering taper 36 components of the outer shell housing 15. The secondary hollow fiber membrane filter 5 is positioned above the primary carbon filter 30, and a seal between filters is formed by means of the filter adapter 34, which is a separate component integrating the filter element 30 with the hollow fiber membrane assembly 5. Axial loading to affect a seal is applied by means of the threaded tensile connection made between the top-mounting ring 22 and the outer shell 15 as the two components are threaded together compressing the “O” ring seal 8 while retaining the filter assemblies and sealing surfaces together. Water enters the shroud through entry port 12, and passes outside of the HFM assembly housing 6 by means of the water distribution channel 13. The water is then drawn, or is forced through the sidewalls of the carbon composite filter 30. The flow of water through the filter is a result of pressure being exerted through squeezing the plastic bottle or a sucking pressure exerted upon the valve 3. The treated water from the primary filter 30 then passes into the water-distribution reservoir 29, distributing the water to the full bundle of hollow fiber membranes 5 for final biological treatment. The water exits through the membranes held in place by potting compound 7, and hence through the valve 3 exiting at the top of the valve 19.

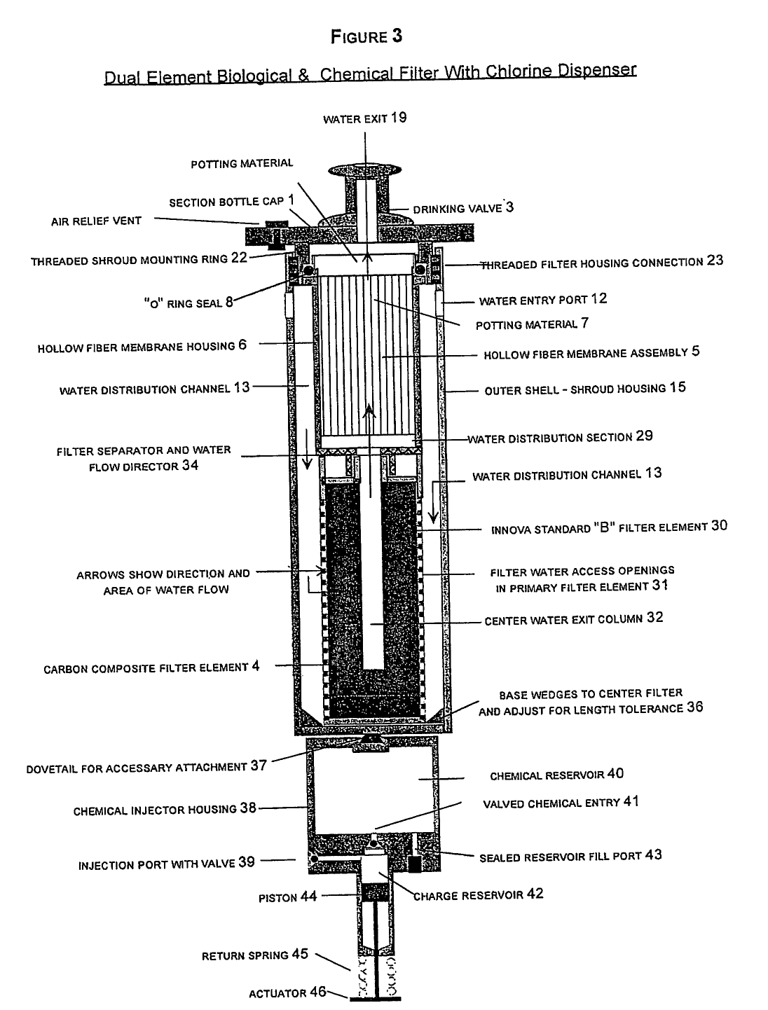

FIG. 3 shows the addition of the viricidal disinfecting injection unit. This unit is designed to affix to the base of the existing filter system housing 15 by means of a dovetail mechanical connection 37, although there are many means of connecting the components such as by threads, a simple friction fit, etc. It must be recognized that while this element becomes an integral element in the purification system, it is nevertheless an optional component added for the purpose of eliminating a viral organism and simplifying the addition of a disinfecting chemical such as chlorine. The elements of this unit are: a housing 38, which contains a reservoir with a sufficient chemical capacity for numerous applications, and the individual dose injection mechanism. As shown in FIG. 3, integrated within the housing is the reservoir 40, a valved chemical entry port 41, a precision charge reservoir 42 which is the dosage, a sealed piston 44, and attached actuator 46. When the filter assembly system is placed into the bottle and the top threaded closed, the actuator is thrust upward by contact with the base of the bottle. As the piston 44, is moved upward it forces the viricide/biocide from the charge reservoir 42, through the valved injection port 39, and into the water-containing bottle. When the filter system assembly is removed from a bottle to fill the bottle with water, the return spring 45 forces the actuator 46 and piston 44 down creating a void and suction causing the valved entry port 41 to open and refill the charge reservoir 42 from the chemical reservoir 40.

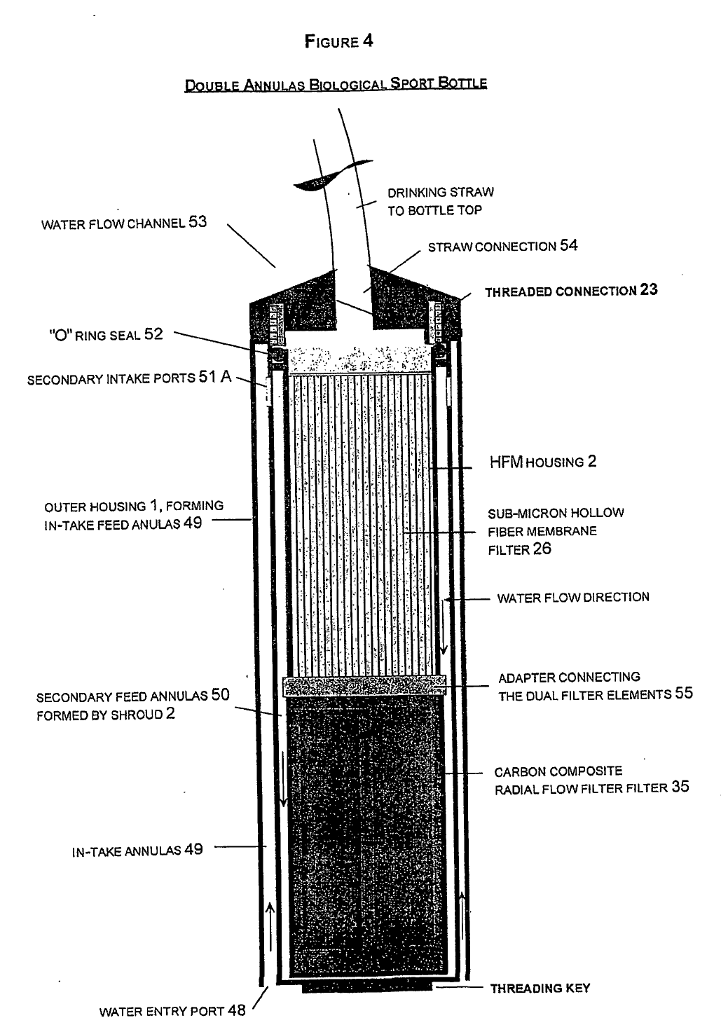

FIG. 4 is yet a different approach using a freestanding carbon composite hollow fiber filter assembly which may be used either in a sport type bottle adapted to straw use, or as a personal product used independently while traveling. In FIG. 4, a unique approach has been taken to assure that the hollow fiber membrane filter is always submerged in water to preclude the possibility of air blockage resulting from water draining from the filter. The subject drawing consists of and outer. housing 1, which forms the intake annulus 49. At the base of the annulus is the water entry port 48 which delivers water on demand to the secondary intake port 51 which in turn provides the water for the secondary feed annulus 50. Water from the secondary annulus 50 transfers radially into the carbon composite filter 35. The water then flows axially through the adapter connecting the dual filter elements 55, and into the H F M housing 2. Within the housing the water enters the sub micron hollow fiber membranes 26, and flows into the straw connection 54, and to the user. The HFM filter 26 with “O” ring seal 52 is attached by means of a friction fit to adapter 55, which in turn forms a friction fit with the carbon composite element 35. The filters are then inserted within the inner housing 51 which in-turn is threaded 23 into outer housing 1. A threading key 23 is molded into the base of inner housing 51 to provide a means to exert threading force.

FIG. 5 shows a dual element filter designed to mount to a specially designed cap which may be used in conjunction with a container such as a bladder or hydration pack which collapses as the water is removed, or to a more rigid bottle with a built in pressure relief valve. In this design, the same basic hollow fiber membrane is used as the biological secondary filter. The primary filter consists of a carbon composite molded block, or one or more carbon fiber discs providing the pre-filtration and chlorine removal capability. A separator support provides the support surface that the post filter 42 nests against. The carbon filtration elements 38 are directly below the post filter 42, and supported in place by pre-filter 41. The pre-filter support 39 supports the post and pre-filter as well as the carbon elements. The post and pre-filters consist of nonwoven fine mesh materials. Below the pre-filter support 39, a duckbill one-way valve is used to retain water previously drawn into the filter elements in order to prevent air from entering the H F M filter during periods of inactivity. In this particular design, the filtration elements are not interchangeable, although the housing 31 could be made into two sections that thread together in the area of the separator support 37. When constructed into sections, the filter elements could be independently changed. At the base of the filter housing 31, a duckbill valve 32 is assembled at the point the housing tapers to a hose, or tube, connection. A pick-up tube 40 is attached to the tube connection and extends to the base of the container for maximum water removal. The threaded connection 34 permits the adaptation of either a drinking tube or push pull drinking valve adding to the flexibility of the design. For assembly, the outer housing 31 is used to sequentially inset the duckbill valve 32, the base of which fits within a molded groove, followed by stacking the prefilter support 39, which nests upon the shoulder formed at the base of housing 31, upon which the prefilter 41, carbon elements 38, and post filter 42 are placed. The separator support 37 is then assembled, and the HFM housing 2 is inserted. HFM housing 2 is used to compress the previously inserted elements and is held in place by compression ring 2A

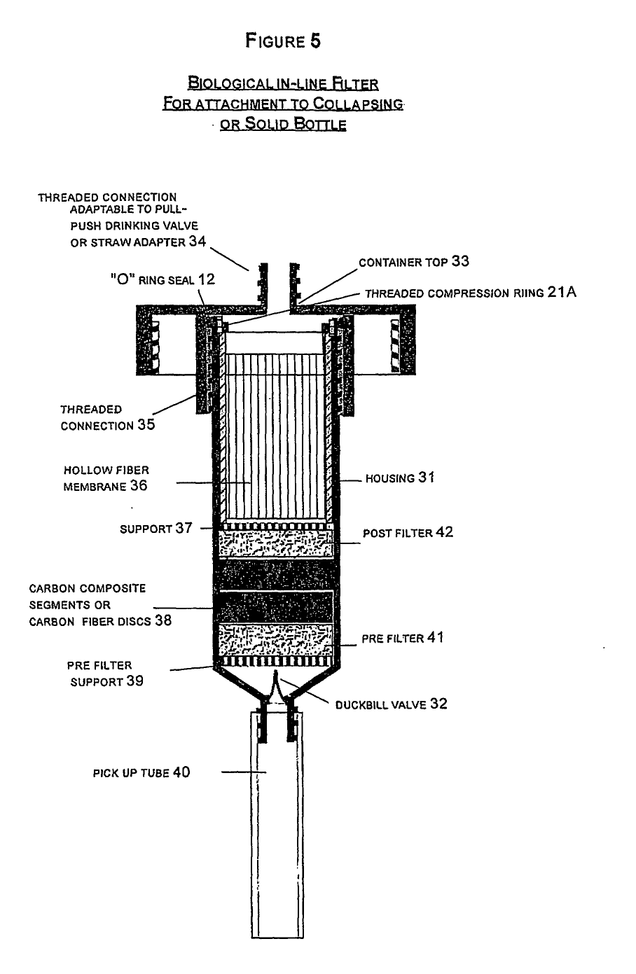

FIG. 6 is a design adaptable to either soft or vented containers to which the filter assembly is fastened to the base or bottom of the container. An advantage of such an arrangement is to provide the head pressure exerted by the fluid within the container to aid in delivering water through the filter to the user. This design is only slightly modified from the preceding designs in that the water entry ports 56 are up at the neck of the container rather than at the base of the filter. Also, the threaded water housing 27 provides a raw water reservoir 28 within the annulus formed. The single porous spacer 55, which is a snap-in friction fit element, retains the nonwoven pre-filter 52, which in turn, is followed by the carbon support porous spacer 62A supporting the carbon composite or carbon fiber disc filters 57, which in turn are separated from the hollow fiber membrane bundle 26 by the support porous spacer 62B, which is a molded in fixed component of the housing 31. A hose fitting 45 is fitted to the container top 43 for use with a drinking tube, however a quick change connection, or shut off type valve may be use if the container is to be hung filled with raw water to be filtered. In applications of this nature, over time, the treated water is fed into a second treated water container positioned below the raw water container with filter.

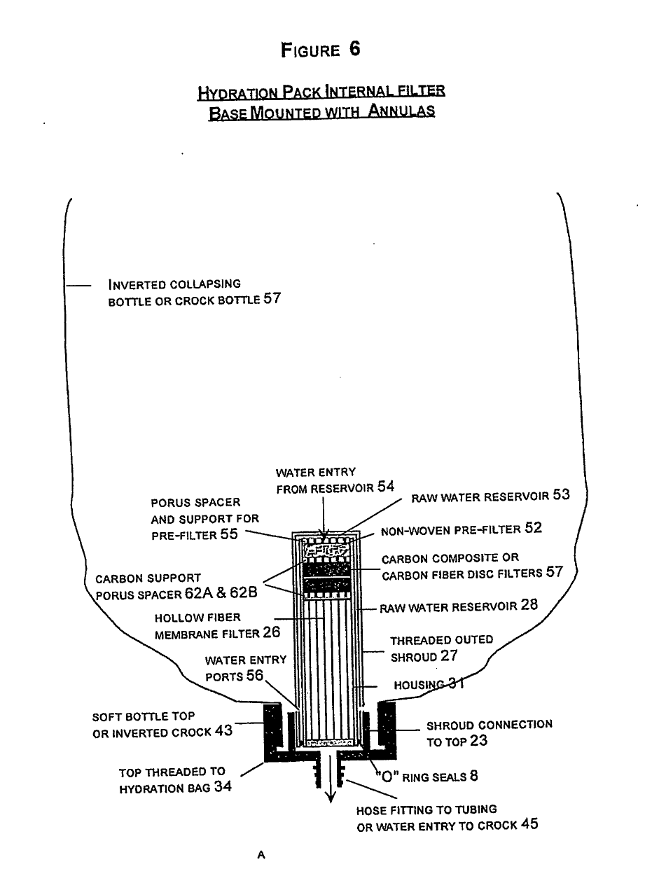

FIG. 7 represents a new filter design positioned within a military canteen from which water may be accessed by two means. The water may be removed by sucking on a straw or by means of a drinking tube affixed to the gas mask adapter. While similar to the preceding designs, there are some major differences that are worth noting which will become apparent as the design is reviewed. The hollow fiber membrane and the carbon composite filter are contained within housing 69 and supported by means of the flange 63 at the top of the housing which fits onto the neck of the canteen and is operatively connected to the canteen top. The flange 63 provides the seal as well as an orientation notch which positions the filter housing radially. The radial positioning places the air relief tube 67 port opposite the air relief valve 65. The air relief valve is contained within the side of the duel flip top 68. The canteen top incorporates both a separate gas mask adapter and drinking straw, which are both maintained in a covered and protected nests ready for use. When flip top lid 68A is opened, the straw 63A flips up, and when the flip top 68A is closed, the straw is retained within the straw receptacle 63B. The gas mask adapter 64 is accessed in a similar manner by opening flip top lid 68B. The air relief valve 65 integrates with the air relief passage 67 which is a thin covered tube formed into the filter housing 69 which feeds air back into the canteen as water is displaced. The groove formed in the housing 69 is turned into a tube by means of a thin Mylar sheet, or similar material 68 which is wrapped or shrunk around the filter housing 69. Due to space limitations, the outer housing directly contains the hollow fiber membrane 26 as well as the integral molded in separator 62 to support the carbon composite elements 57, which may be either carbon composite block, GAC, or carbon composite cloth. A porous carbon element retainer 70, while supporting the carbon element 57, also provides an incoming water distributional channel to the carbon elements. The base retainer rests upon and is supported by base plate 21. A unidirectional valve 24 is assembled and secured within a nest to the base plate 21 water entry port to retain water within the filter assembly to reduce the chance of air blockage caused by water having been drawn into the HFM element and consequently draining back into the canteen during the time the filter was not in use. The base plate 21 is threaded onto the housing 69. A water pick-up tube 59 extends to the bottom of the canteen.

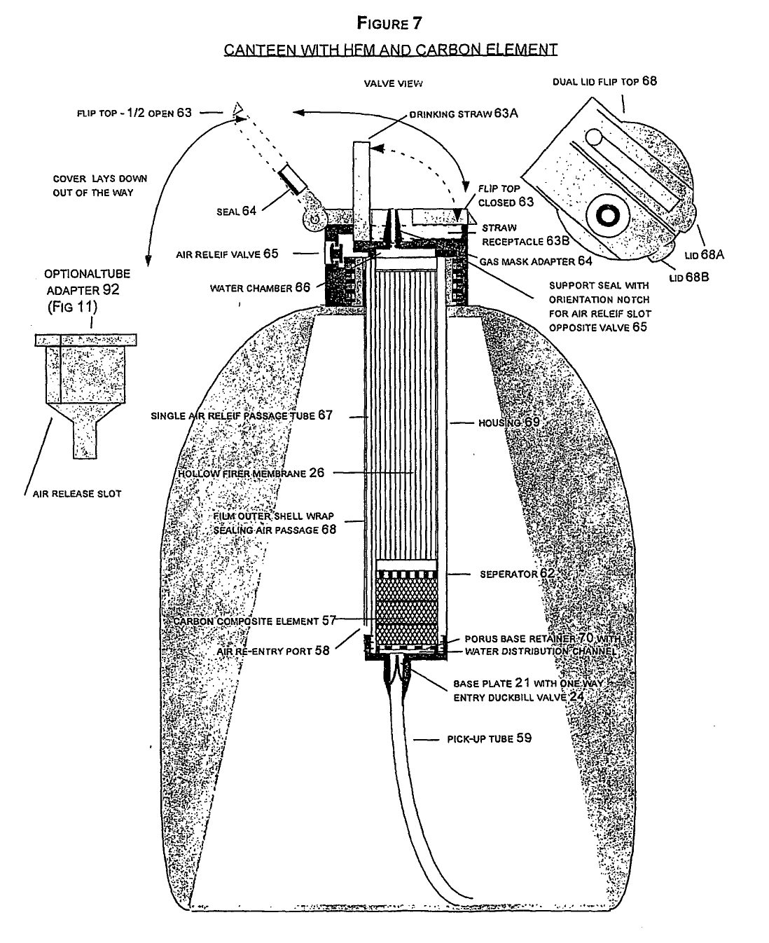

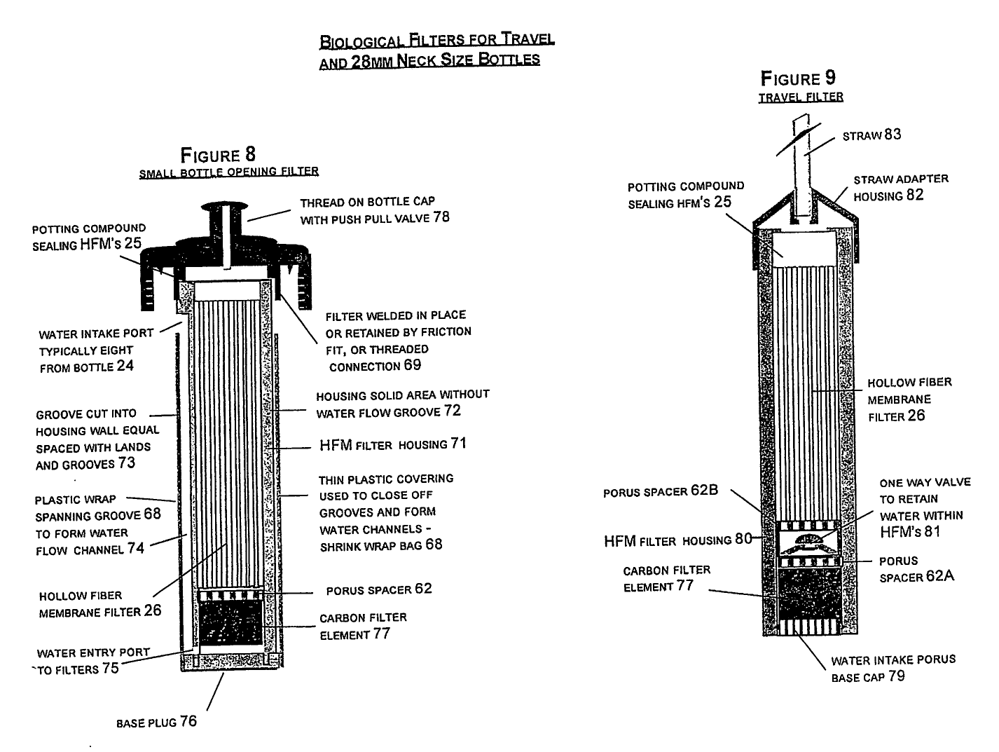

FIG. 8 is the design of the combined carbon composite and hollow fiber membrane filter for use in the standard 28 mm neck P E T bottles which are used for water and soft drinks. In this particular design, the filter housing 71 is secured in place, or retained, by a friction fit or threaded connection to the cylindrical boss on the bottle cap with push pull valve 78, which is an industrial standard. The user when refilling this bottle does not touch the filter assembly which is in contact with the water, thus eliminating this potential for contamination. A series of longitudinal grooves 73 molded into the filter housing 71 are the major differences in actual filter design and construction. These grooves which extend from the base of the filter housing to within approximately three quarters of an inch of the top of the housing are closed to within ⅛ in of the top of the grooves to form tubes 68 which function as water flow channels. The grooves are closed by shrink-wrapping a plastic sleeve 68 around the filter housing 71 converting the grooves into tubes, or channels. Water intake ports 24 are placed in the top of the water tubes. Water outlet ports 75 into the filter area are molded into the base of the filter housing 71 and closed to the external surfaces by means of the base plug 76, which is retained in place by either a snap fit into a groove within the base of the housing 71, or by the shrink wrapped film. A single monolithic carbon filter element 77 is incorporated within the design, although carbon fabric disks or granulated activated carbon could also be used. As the water inlet 24 is near the top of the HFM filter, water cannot drain from the filter causing air blockage or requiring water to be drawn back through the filter with each use.

FIG. 9 represents a similar size filter employing essentially the same hollow fiber membrane bundle 26 and carbon composite filter element 77. This particular design is for use by the traveler and may be used to drink through from a glass or cup or a bottle through a straw provided neither the cap or straw cap interface on the bottle is airtight. The filter housing 80 has a straw adapter housing 82 permanently affixed by mechanical, adhesive, welding, or other means. A tube which functions as a straw 83 is held in place in the adapter housing receptacle by means of a friction fit. The water is drawn through the porous water intake base cap 79, which also retains the carbon filter element 77. The base cap 79 contains a 0.10″ ring which effects a snap retainer into a mating groove within the housing 80. It is desirable to add a check valve 81 which nests on top of spacer 62A to prevent water from draining from the hollow fiber membrane filter element 26. The valve 81 is positioned between porous spacer 62A and porous spacer 62B.

FIG. 10 is again for use in a relatively narrow neck bottle similar to the International Standard 28 mm. This particular filter is similar to the filter described in FIG. 8 with the exception that it utilizes a flange. The flange rests upon the top of the bottle neck and is operatively connected with the bottle and the top when the top is threaded into position. This design is to be used with a top containing a valve, be it a pull push type or straw that can be pinched closed. The bottle must be either collapsing or contain a re-inflation valve. The filtration assembly containing a carbon composite element 57 and the hollow fiber membrane filter 26 is assembled within the inner housing 94. The carbon element is retained in place by press fit lock ring 69 and the porous separator 70. This assembly is placed within the outer housing 93 and welded to the outer housing 93. The bottle mounting flange 68 is a component of the outer housing 93. The top of the flange is open to permit water exit over area 25. The end of the outer housing is sealed by base plug 70 which snaps into outer housing 93.

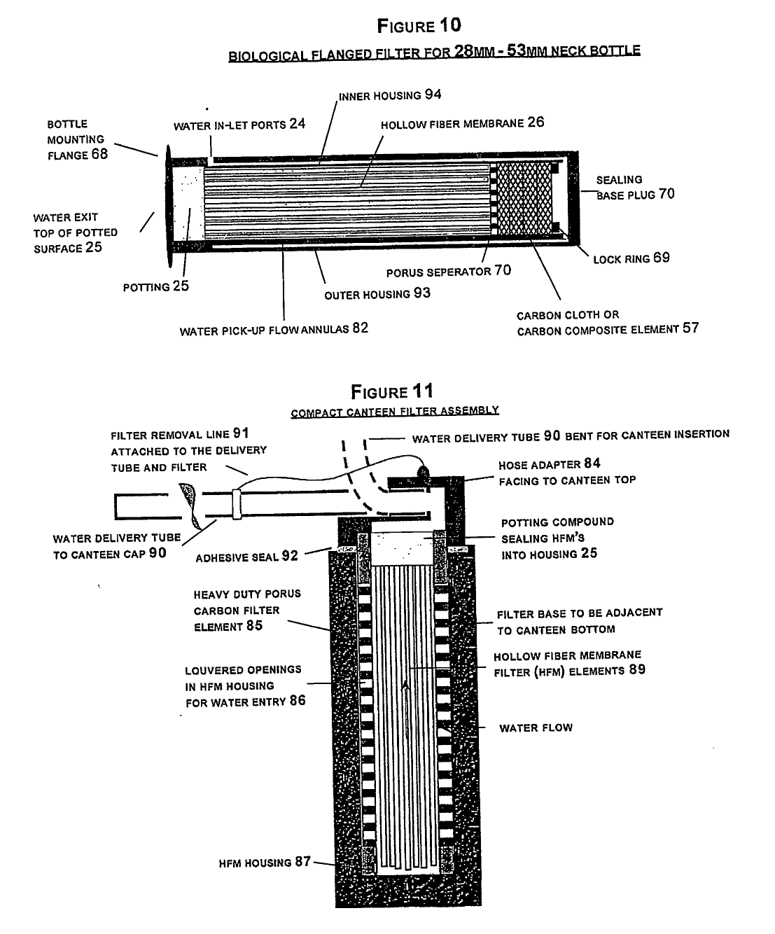

FIG. 11 presents a departure from the other designs permitting a minimum length to be obtained with significantly increased capacity to remove chlorine and other selected elements with a minor increase in diameter. The hollow fiber biological membrane 89 is contained within a housing with louver type openings which cover most of the length of the H F M filter element 89, providing water access. The louvered housing 86 is covered by an extruded carbon composite closed-end sleeve. The tube or straw adapter 84 is shown connecting to the filter housing 87 above the adhesive seal 92 and may be either welded or threaded in place. Following the assembly of the straw adapter 84, the carbon element 85 is bonded in place to the base of the adapter 84. The hose adapter 84 is designed to support the delivery tube 90 at right angles to the axis of the filter assembly allowing the filter assembly to rest upon the bottom of the canteen in a horizontal plane while the delivery tube extends vertically upward to the canteen cap. A feature of the hose adapter 84 is the relief at the top of the adapter to permit the delivery tube to be bent 90 degrees to facilitate placement within a relatively small diameter canteen opening. For filter removal, a line or lanyard 91 is attached to the delivery tube 90 and to the end of the hose adapter 84. When the tube 90 is pulled from the hose adapter 84, the removal line 91 allows the filter assembly to assume a vertical orientation for easy removal from the relatively narrow neck canteen as the tube with chief attached filter are withdrawn.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A water filter cooperable with a water container, the water filter comprising:
a carbon composite filter; and
a bundle of sub-micro porous hollow fiber membranes in fluid communication with said carbon composite filter,
wherein the carbon composite filter and the hollow fiber bundle are arranged in the water container such that untreated water is first treated with the carbon composite filter and then directed to the hollow fiber bundle, and
wherein an influent side of the hollow fiber bundle is continuously immersed in water whereby air is prevented from being re-introduced to the hollow fiber bundle from outside the water filter between inversions of the water container or when the water container is upright.

2. A water filter according to claim 1, further comprising an outer shroud housing the carbon composite filter and the hollow fiber bundle, the outer shroud having at least one water inlet port for untreated water and being formed of a material substantially impervious to water.

3. A water filter according to claim 2, wherein the shroud is configured to permit substantially total removal of water from the water container while retaining the water within the filtration elements.

4. A water filter according to claim 2, wherein the outer shroud is formed in multiple disassemblable pieces.

5. A water filter according to claim 2, wherein the outer shroud comprises exterior longitudinal grooves, and wherein the outer shroud is covered with a sheet of a plastic material defining water delivery tubes with said grooves, the water delivery tubes maintaining a water level within the outer shroud to preclude water from draining from the water filter and prevent entry of air therein.

6. A water filter according to claim 5, wherein one of the water delivery tubes extends a full length of the water filter and is sealed from water, the one tube serving as an air relief port through the water container.

7. A water filter according to claim 1, wherein the carbon composite filter and the hollow fiber bundle are arranged in a nesting configuration.

8. A water filter according to claim 1, wherein the hollow fiber bundle comprises a pore size between 0.1-0.3 micron.

9. A water filter according to claim 1, wherein the carbon composite filter is a composite monolithic block in a closed end cylinder configuration comprising activated carbon and binder.

10. A water filter according to claim 9, wherein the carbon composite filter further comprises zeolyte, ion exchange materials and polymer extractive material.

11. A water filter according to claim 9, wherein the carbon composite filter has an outer surface area of at least 9 in².

12. A water filter according to claim 1, wherein the carbon composite filter and the hollow fiber bundle are independently interchangeable.

13. A water filter according to claim 1, wherein the hollow fiber bundle is between 2-3 inches in length and at least 1 inch in diameter containing at least about one square foot of available membrane treatment surface area.

14. A water filter according to claim 1, wherein the carbon composite filter and the hollow fiber bundle are arranged end to end.

15. A water filter according to claim 14, further comprising a single mount coupleable with the water container.

16. A water filter according to claim 1, further comprising a pre-filter disposed upstream of the carbon composite filter.

17. A water filter according to claim 16, wherein the pre-filter comprises woven and non-woven material or screen with a pore size of about 10 microns.

18. A water filter according to claim 17, wherein the pre-filter contains a densified carbon composite filter element with a pore size between about 10-20 microns.

19. A water filter according to claim 1, further comprising a chemical disinfecting automatic injector in fluid communication with the carbon composite filter and the hollow fiber bundle, the chemical disinfecting automatic injector including a chemical reservoir and a release mechanism.

20. A water filter according to claim 19, wherein the chemical disinfecting automatic injector is an independent component capable of being selectively attached and removed.

21. A water filter according to claim 20, wherein the chemical reservoir is refillable.

22. A water filter according to claim 20, wherein the chemical reservoir is permanently sealed.

23. A water filter according to claim 19, wherein the chemical reservoir is sized to contain multiple chemical doses comprising one of chlorine, iodine and derivatives thereof.

24. A water filter according to claim 19, wherein the release mechanism releases a predetermined chemical dosage.

25. A water filter according to claim 24, wherein the predetermined chemical dosage is selectively adjustable.

26. A water filter according to claim 24, wherein the release mechanism is engageable with the water container to effect release of the predetermined chemical dosage.

27. A filtration system for filtering water, the filtration system comprising:
a water container; and
a water filter cooperable with the water container, the water filter including:
a carbon composite filter, and
a bundle of micro porous hollow fiber membranes in fluid communication with said carbon composite filter,
wherein the carbon composite filter and the hollow fiber bundle are arranged in the water container such that untreated water is first treated with the carbon composite filter and then directed to the hollow fiber bundle, and
wherein an influent side of the hollow fiber bundle is continuously immersed in water whereby air is prevented from being re-introduced to the hollow fiber bundle from outside the water filter between inversions of the water container or when the water container is upright.

28. A filtration system according to claim 27, wherein the water container comprises a bottle and a bottle top, and wherein the water filter is operatively connectable between the bottle and the bottle top, and wherein the water filter extends into the bottle.

29. A filtration system according to claim 28, wherein the bottle top comprises a removable valve assembly.

30. A filtration system according to claim 27, wherein the water container comprises a bottle having an air relief valve, permitting water to be pressured into and through both the carbon composite filter and the hollow fiber bundle.

31. A filtration system according to claim 30, which utilizes an umbrella type silicon valve with a cracking pressure of between 0.5 and 3 psig depending upon application and container resilience.

32. A filtration system according to claim 27, wherein the carbon composite filter and the hollow fiber bundle are arranged end to end, and wherein the water filter comprises a single mount coupleable with the water container.

33. A filtration system according to claim 27, wherein the water container comprises a bottle having a neck, and wherein the water filter extends into the bottle entirely below the neck.

34. A filtration system according to claim 27, wherein the water container comprises a bottle and a bottle top, and wherein the water filter is secured to the bottle top via a secure waterproof connection.

35. A filtration system according to claim 27, wherein the water container comprises a durable plastic bottle.

36. A filtration system according to claim 27, wherein the water container comprises a multi-gallon crock-type container, and wherein the water filter is positioned in a bottom of the crock-type container such that water flows through the water filter by means of head pressure or siphon.

37. A filtration system according to claim 36, wherein the crock-type container is self-venting.

38. A filtration system according to claim 27, wherein the water container is a collapsible bottle or bladder comprising a water valve, and wherein the water filter is coupled with the water valve via a drinking tube.

39. A filtration system according to claim 38, wherein an adapter of the drinking tube secures the water filter within a neck of the collapsible bottle or bladder.

40. A filtration system according to claim 27, wherein the water container is a bottle having a 28-35 mm neck bottle cap with an air relief valve, and wherein the carbon composite filter and the hollow fiber bundle are mounted in a single housing.

41. A filtration system according to claim 27, wherein the water filter is mountable inside the water container and further comprises a chemical disinfecting automatic injector in fluid communication with the carbon composite filter and the hollow fiber bundle, the chemical disinfecting automatic injector including a chemical reservoir and a release mechanism, wherein the release mechanism is actuated to discharge a chemical dosage upon insertion of the water filter in the water container.

42. A filtration system according to claim 27, wherein the water container is a canteen.

43. A dual component water filter comprising a hollow fiber membrane bundle and a screen pre-filter, the hollow fiber membrane bundle and the screen pre-filter being contained within a single housing, wherein the housing retains water within the hollow fiber membrane bundle and the screen pre-filter.

44. A dual component water filter according to claim 43, wherein the housing is shrink-wrapped with a plastic film.

45. A dual filter element comprising a sub-micron internal filter nested within a carbon composite outer filter shell, the sub-micron internal filter and the carbon composite outer shell both being of a radial flow design.

46. A dual filter element according to claim 45, further comprising a straw extending substantially 90 degrees to an axis of the filter element.

47. A dual filter element according to claim 46, wherein the straw is bendable at 90 degrees to facilitate placement within a container having an opening diameter that is sufficiently large to permit insertion of the filter element axially.

48. A dual filter element according to claim 46, wherein the filter element is configured for removal from a narrow necked container by means of a lanyard attached to the straw, an end of the filter providing for ease of removal upon stripping the straw from the filter element.
